(19) United States
(12) Patent Application Publication
(10) Pub. No.: US 2025/0340784 A1
(43) Pub. Date: Nov. 6, 2025

(54) METHOD OF PREPARING HYDROGEN AND LIQUID FUEL FROM A PLASTIC FEEDSTOCK

(71) Applicant: Quantafuel ASA, Oslo (NO)

(72) Inventors: Kumar R ROUT, Oslo (NO); De CHEN, Oslo (NO); Lars Erik FAREID, Oslo (NO); Erik FAREID, Oslo (NO)

(73) Assignee: Quantafuel ASA, Oslo (NO)

(21) Appl. No.: 18/867,425

(22) PCT Filed: May 16, 2023
(86) PCT No.: PCT/EP2023/063126

§ 371 Date: Nov. 19, 2024

(30) Foreign Application Priority Data
May 19, 2022 (GB) 2207351.4

(51) Int. Cl. C10G 1/10; C01B 3/22

(52) U.S. Cl. CPC C10G 1/10; C01B 3/22; C01B 2203/0216; C01B 2203/042; C01B 2203/0475; C01B 2203/065; C01B 2203/1211; C10G 2300/1003; C10G 2300/4006; C10G 2300/4012; C10G 2300/42; C10G 2300/807

(57) ABSTRACT

Disclosed herein is a method of preparing hydrogen and liquid fuel from a feedstock that comprises plastics, the method comprising: generating a first gas stream, that is a pyrolysis gas, by performing a pyrolysis process on the feedstock; condensing some of the first gas stream to generate a second gas stream and pyrolysis oil, wherein the second gas stream is a light component of the pyrolysis gas; performing a reforming process on the second gas stream to generate hydrogen; and generating liquid fuel by performing a hydrogenation process on the pyrolysis oil; wherein the hydrogenation process reacts the pyrolysis oil with at least some of the generated hydrogen by the reforming process.

### FIELD OF THE INVENTION

The present invention relates to processes for the preparation of fuels, such as naptha and/or hydrogen, from plastic by pyrolysis and reforming processes.

### BACKGROUND TO THE INVENTION

A substantial proportion of the world's population are heavily reliant on liquid hydrocarbon fuels, that have been obtained from crude oil, for transportation and other uses. A problem with the use of such non-renewable energy sources is that they substantially increase greenhouse gas emissions.

There is therefore a lot of interest in the generation and use of clean fuels, such as hydrogen. There is also a lot of interest in generating fuels, and other useful products, from waste materials. In particular, there is a desire to efficiently generate useful products from waste plastics. This is a more efficient use of resources and may also reduce the use of fuels that have been obtained from crude oil.

There is a general need to improve the generation of useful products from plastics.

### SUMMARY OF THE INVENTION

Aspects of the invention are set out in the appended independent claims. Optional aspects are set out in the dependent claims.

### BRIEF DESCRIPTION OF THE DRAWINGS

FIG. 1 schematically shows a system according to embodiments.

### DETAILED DESCRIPTION OF THE INVENTION

Embodiments of the present invention are concerned with the preparation of useful products from plastics. A fast pyrolysis reaction may be performed on the plastics and the resulting products may be used to produce hydrogen and useful liquid products. The generated liquid products may comprise liquid fuels such as naptha and higher hydrocarbon fuels.

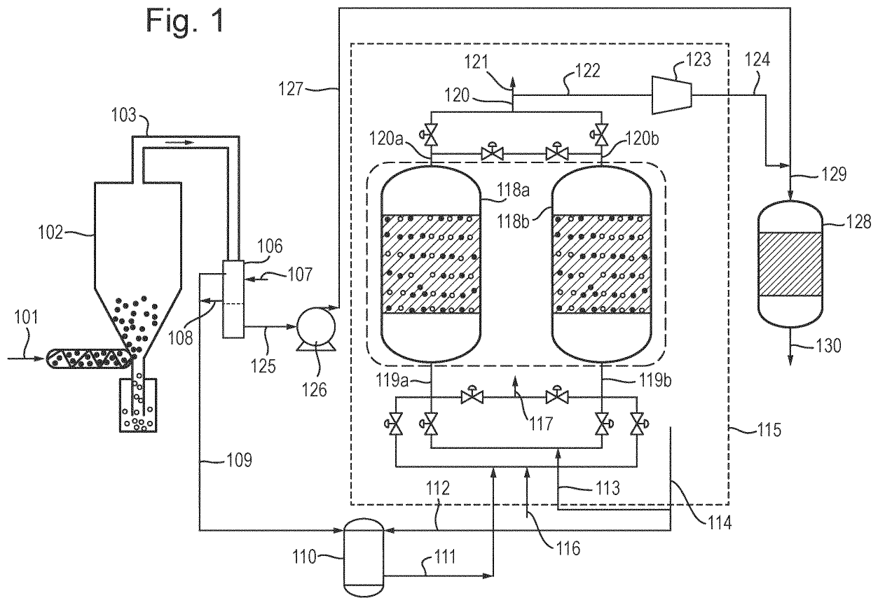

FIG. 1 schematically shows a system according to embodiments. Components that the system may comprise include a pyrolysis reactor 102, a condenser 106, a steam gasification reactor 110, a reforming system 115 and a hydrogenation reactor 128. The reforming system 115 may comprise reforming reactors 118a and 118b.

As will be described in more detail below, the system according to embodiments may be operated in a number of different configurations with the system using different components in each of the configurations. One or more of the components shown in FIG. 1 may therefore be optional to the extent that embodiments include a configuration of the system that does not use the one or more components.

The system according to embodiments may also comprise further components to those shown in FIG. 1. For example, the system may comprise pumps, coolers, heaters, heat exchangers, valves, manifolds, temperature sensors, pressure sensors, controllers and any other components required for the operation of the system.

A first embodiment is described below.

Feed 101 is a supply of plastics into the system. The plastics may be obtained from waste materials. The source of plastics may be household waste plastics and/or industrial waste plastics. The source of plastics may include High Density Poly Ethylene (HDPE) and/or Low Density Poly Ethylene (LDPE).

The plastics may optionally be pre-processed before being supplied to the feed. The pre-processing may, for example, remove PVC by mechanical sorting and/or chemical processing.

The pyrolysis reactor 102 may receive the plastics from the feed 101. The pyrolysis reactor may perform a pyrolysis process, such as a fast pyrolysis process, on the received plastics. The reaction of the pyrolysis process may be performed at about 400° C. to 500° C.

Fast pyrolysis involves heating the plastics in the reactor in an inert atmosphere. Accordingly, there is no O₂ present when the plastics are heated. Thus, the processes typically involve heating the plastics to 300° C. to 600° C., preferably 400 to 450° C. The heating is rapid, hence it being “fast”. Typically, processes occurs at a pressure of 5 to 50bar, preferably 5 to 20 bar. Typically heat is supplied at a rate of 1500 to 2500 J/g of plastics. Typically, the flux is above 50 W/cm².

The fast pyrolysis process may be carried out in the presence of a catalyst. If heat for fast pyrolysis is provided through a fluidized bed, then catalyst particles can either be mixed with the material of the fluidized bed or supported on the particles being fluidized. An example would be sand used as a circulating fluidized material to supply heat for fast pyrolysis. In such a case, the catalyst may either be mixed with the sand or supported on the sand particles. Typically, however, the fast pyrolysis process is carried out in the absence of an catalyst.

The pyrolysis process may generate a gas mixture that comprises a mixture of hydrocarbon based gasses. The gas mixture may comprise light hydrocarbon based gasses with, for example, 1 to 4 carbon atoms in each molecule (referred to as C₁-C₄ hydrocarbons). The gas mixture may comprise olefins and/or parafins. The gas mixture may also comprise medium and heavy hydrocarbon based gasses with, for example, 5 or more carbon atoms in each molecule. The number of carbon atoms in a molecule may be, for example, 40 or 60.

The gas mixture generated by the pyrolysis process may leave the pyrolysis reactor 102 through the pyrolysis reactor output conduit 103. The gas that in the pyrolysis reactor output conduit 103 may be referred to as a first gas stream

The pyrolysis reactor output conduit 103 may supply the gasses generated by the pyrolysis process to the condenser 106.

The condenser 106 may be arranged to cool the gasses in the gas mixture supplied to it through the pyrolysis reactor output conduit 103 so that at least some of the medium and/or heavy hydrocarbon based gasses condense. The condenser 106 may comprise a fluid inlet conduit 107 and a fluid outlet conduit 108 for supporting a flow of cooling fluid through the condenser 106. The cooling fluid may be, for example, water. The condenser 106 may comprise one or more heat exchangers for heat exchange between the received gas mixture and the cooling fluid so that the received gas mixture is cooled by the cooling fluid.

The condenser 106 may be any of a number of known designs of condenser 106.

The gasses that condense in the condenser 106 may be referred to as pyrolysis oil. The gasses that do not condense in the condenser 106 may be referred to as pyrolysis gas. The pyrolysis oil, i.e. the gasses that condense in the condenser 106, may be supplied as a liquid flow to a fluid output conduit 125. The pyrolysis oil may comprise, for example, a light fraction, a medium fraction and a heavy fraction. The light fraction may comprise naptha and have carbon length in the range 6 to 12. About 20% to 30% of the pyrolysis oil may be the light fraction. About 20% of the pyrolysis oil may be the medium fraction. About 50% to 60% of the pyrolysis oil may be the heavy fraction.

The fluid output conduit 125 may supply the pyrolysis oil to a pump 126. The pyrolysis oil may flow through the pump 126 and into a pyrolysis oil supply conduit 127.

The pyrolysis gas, i.e. the gasses that are not condensed in the condenser 106, may be supplied to a gas output conduit 109. The gasses in gas output conduit 109 may be referred to as a second gas stream. The gasses in gas output conduit 109 may comprise, for example, one or more of methane, ethane, propane, butane, ethylene, propylene, propene, hydrogen, carbon monoxide, carbon dioxide and other non-condensable gasses. The substantial component of the pyrolysis gas may be ethylene.

The gasses in gas output conduit 109 may be supplied to the steam gasification reactor 110. The steam gasification reactor 110 may also receive a supply of steam. The steam may be supplied to the steam gasification reactor 110 by a second steam conduit 112. Within the steam gasification reactor 110, at least some of the received hydrocarbon based gasses may react to generate different gasses. In particular, at least some of the gasses that comprise double carbon bonds may be converted into gasses that comprise single carbon bonds. For example, ethylene may be converted to ethane. The processes performed in the steam gasification reactor 110 may also generate hydrogen, carbon monoxide and/or carbon dioxide. The steam gasification process may be performed at between 400° C. and 800° C., and preferably at 600° C. The steam gasification process may be performed at a pressure of about 1 to 10 bar, and preferably about 5 to 10 bar.

The products of the processes performed in the steam gasification reactor 110 are gasses that may be supplied to a reforming product supply conduit 111. The reforming product supply conduit 111 may comprise one or more of methane, ethane, hydrogen, carbon monoxide, carbon dioxide and other gasses.

The system may comprise a steam generator. The steam generator may be, for example, a water boiler. The steam generator may use waste heat from, for example, the pyrolysis reactor 102, the steam gasification reactor 110 and/or the reforming system 115 to heat water to generate steam. Steam that is generated in the steam generator may be output through a first steam conduit 114. The first steam conduit 114 may supply the steam to the second steam conduit 112 and a third steam conduit 113.

The reforming system 115 may receive the hydrocarbon based gasses from the reforming product supply conduit 111, steam from the third steam conduit 113 and air from an air supply conduit 116. Within the reforming system 115, reforming processes may be performed on the received the hydrocarbon based gasses to generate hydrogen and carbon dioxide. A gas capture process may also be performed to separate the generate hydrogen and carbon dioxide.

Preferably, the same one or more reactors may be used to perform the reforming and gas capture processes. In particular, the reforming system may comprise one or more reactors 118a, 118b for performing reforming processes. Each reactor may have an first conduit 119a, 119b arranged to either provide a gas flow to the reactor 118a, 118b or to receive a gas flow from the reactor 118a, 118b. Each reactor may also have a second conduit 120a, 120b arranged to receive a gas flow out of the reactor 118a, 118b.

The one or more reactors may be fixed bed reactors 118a, 118b. Each fixed bed reactor 118a, 118b may be arranged to perform a sorption enhanced steam reforming process (SESR). In a SESR process, a reactor may be arranged to both perform a reforming process and the reactor may also comprise a sorbent for capturing a product of the reforming process. The reforming process may generate hydrogen and carbon dioxide. The sorbent in the reactor may capture, e.g. absorb or adsorb, the carbon dioxide to leave substantially pure hydrogen as the remaining product of the reforming process. The hydrogen may then flow out of the reactor. The reactor may then be operated under different conditions so that the sorbent releases the carbon dioxide in a sorbent regeneration process. The carbon dioxide may then flow out of the reactor. The reactor may then receive a new supply of products for reforming and the processes repeated.

SESR may be an integrated process involving steam reforming of a stream comprising C₁-C₄ hydrocarbons, CO and CO₂ in the presence of a sorbent suitable for CO₂ capture, thereby to produce H₂. Each reactor 118a, 118b may contain a catalyst required for the steam reforming process together with a sorbent suitable for CO₂ capture for the in-situ removal of carbon dioxide from the gaseous phase. The steam reforming, including water gas shift (WGS) and CO₂ capture reactions, may be conducted simultaneously in each reactor 118a, 118b.

The steam reforming may use a steam reforming catalyst, such as Ni, Co or Ni—Co, or noble metal (i.e. Pt, Pd, Ru, Rh) promoted versions of Ni, Co or Ni/Co. Pd promoted Ni—Co (i.e. Pd/Ni—Co) is particularly preferred. Ni catalysts are commonly used in steam reforming processes because they have high activity and selectivity towards hydrogen products. The specific catalyst may be: 1% Pd/20%Co20%NiHT (having a pellet diameter in the range 0.25-0.5 mm) that has been prereduced for 10 hours in 25% H2/N2 (200 mL/min). The mass of each pellet may be 0.3 g.

Steam reforming involves the reaction of C₁-C₄ hydrocarbons and CO with water to provide hydrogen and CO₂. The reactions involved can be illustrated for methane as follows:

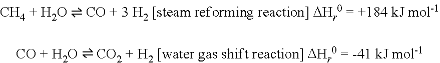

Both of the above reactions are reversible, and so the reactions can be driven towards H₂ production by removal of CO₂. Removal of CO₂ is achieved by conducting the steam reforming steps in the presence of a sorbent suitable for CO₂ capture. The sorbent reacts with the CO₂, generally as soon as it is formed, thereby driving the equilibrium towards H₂ production.

Any sorbent that is suitable for CO₂ capture can be used, but generally CaO-based sorbents are preferred. Natural limestone (primarily CaCO₃) and dolomite (primarily CaCO₃·MgCO₃) based sorbents being particularly preferred due to their low cost and ready availability (despite suffering from a decay in their CO₂ capture capacity after several cycles of carbonation/regeneration). These natural materials can be converted into their oxides by heating, thereby to provide the sorbent. The specific sorbent may be calcined dolomite AGRIKALK (with the calcination performed at 800° C. for 6 hours) (having a pellet diameter in the range 0.25-0.5 mm). The mass of each pellet may be 4 g.

For example, a sorbent material can be prepared from limestone (CaCO₃) by heating it to provide CaO (and CO₂). The CaO sorbent can then react with CO₂ to reform the CaCO₃,

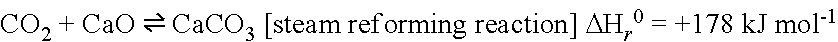

thereby removing the CO₂ from the atmosphere. This reaction occurs at low CO₂ partial pressures and at moderate temperatures and has fast kinetics and good adsorption capacities. When desired, the CaO sorbent can be regenerated from the thus-formed CaCO₃ by heating, with the relatively pure stream of CO₂ produced as a by-product being suitable for other uses or sequestration.

In a temperature swing SESR, the reactor is operated at different temperatures for the reforming process and the sorbent regeneration process. The sorbent regeneration process may be performed at a higher temperature than the reforming process.

The conditions of the reforming process and the sorbent regeneration process in a SESR reactors may alternatively differ by the pressure in the reactor so that there is a pressure swing.

At any one time, each reactor may be operated in one of a plurality of operating modes that include an operating mode in which hydrogen flows out of the reactor and an operating mode in which carbon dioxide flows out of the reactor. When there are a plurality of SESR reactors, at least one of the reactors may be always be operated with hydrogen flowing out of it so that there is a substantially continuous flow of hydrogen out of the system.

The H₂ production can alternatively be done based on carbonate looping by a circulating fluidized-bed (CFB) reactor, where one fluidized-bed acts as a reformer where steam reforming, water gas shift and CO₂ removal by the solid sorbent occurs simultaneously and the other release CO₂ from the solid sorbent (thereby regenerating the sorbent). The solid sorbent circulates between the two reactors.

The reactors 118a and 118b of the reforming system 115 may be operated at any suitable temperatures and pressures for the processes performed therein. For example, the operating temperatures may be in the range 500° C. to 700° C., and preferably 600° C. to 650° C., or 625° C. to 675° C. The operating pressures may be in the range 1 to 5 bar.

The reforming system 115 may output the generated hydrogen to a first hydrogen conduit 120. The first hydrogen conduit 120 may supply hydrogen to both a second hydrogen conduit 121 and a third hydrogen conduit 122. The second hydrogen conduit 121 may be a main output of hydrogen from the reforming system 115.

Other gasses generated in the reforming system 115 include carbon dioxide. The carbon dioxide may be output through a carbon dioxide conduit 117. The gas in the carbon dioxide conduit 117 may be a gas mixture that comprises carbon dioxide and one or more other gasses, such as nitrogen. The carbon dioxide may be separated from any other gasses before being compressed and transported for storage and/or use.

The third hydrogen conduit 122 may supply the hydrogen to a compressor 123. The hydrogen may flow through the compressor 123 and into a fourth hydrogen supply conduit 124. The compressor 123 is optional. The compressor 123 may compress the hydrogen to a pressure of 1 to 5 bar.

The hydrogen in the fourth hydrogen supply conduit 124 may be mixed into the pyrolysis oil in the pyrolysis oil supply conduit 127. The hydrogen and pyrolysis oil mixture may be supplied to a hydrogenation reactor input conduit 129.

The hydrogenation reactor 128 may receive the hydrogen and pyrolysis oil mixture from the hydrogenation reactor input conduit 129. The hydrogenation reactor 128 may be arranged to perform hydrogenation reactions that convert the double carbon bonds in the components of the pyrolysis oil into single carbon bonds. The hydrogenation process in the hydrogenation reactor 128 may be performed at about 150° C. to 250° C., and preferably about 200° C., and at a pressure of about 5 to 10 bar. The output products of the hydrogenation reactor 128 may supplied to a main liquid output conduit 130. The products supplied to the main liquid output conduit 130 may comprise liquid fuels, such as naptha with a carbon chain length of 6 to 12.

The liquid fuel prepared according to embodiments comprises liquid hydrocarbons. The liquid hydrocarbons typically contain five or more carbon atoms (C₅₊ hydrocarbons). Preferably the liquid fuel comprises a high proportion of C₈-C₁₃ hydrocarbons, such as C₉ hydrocarbons.

Advantageously, the system according to the first embodiment converts waste plastic into the useful products of hydrogen and liquid fuel. In addition, the carbon dioxide generated by the performed processes is captured so it is not directly released into the atmosphere.

According to a second embodiment, the processes are as described for the first embodiment except that there is either no steam gasification reactor 110, or the steam gasification reactor 110 is present but it is selectively bypassed so that it is not used. In the second embodiment, no processes are performed for converting the components of the pyrolysis gas that comprise double carbon bonds so as to have single carbon bonds. The pyrolysis gas may instead be fed directly to the reforming system 115. In the second embodiment the reforming system 115 may therefore receive ethylene as a main component of its feedstock, whereas in the first embodiment the reforming system 115 may receive ethane as a main component on its feedstock.

In the above-described embodiments, the products supplied to the main liquid output conduit 130 are generated by hydrogenation of the pyrolysis oil. The pyrolysis oil may comprise carbon chain with lengths in the range 5 to 40. However, only the carbon lengths 5 to 20 may be a desired main output product of the system. The components of the pyrolysis oil with carbon lengths 21 to 40 may be converted into heavy fuels by the processes in hydrogenation reactor and supplied to the main liquid output conduit 130. If the heavy fuels are not desired in the output product, further processes may be performed to separate the heavy fuels from the lighter ones and/or to convert the heavy fuels to lighter ones.

Advantageously, the system according to embodiments converts waste plastic to into the useful products of hydrogen and naptha fuel. In addition, the carbon dioxide generated by the performed processes is captured so it is not directly released into the atmosphere.

The input products, i.e. feedstock, to the system, through the feed 101, may be substantially only plastics materials and these may be waste plastics. The content of the pyrolysis gas is dependent on the feedstock. When the feedstock is substantially only plastics materials, the above-described processes of embodiments efficiently generate hydrogen and naptha fuel as described.

Embodiments also include the input products, i.e. feedstock, to the system, through the feed 101, comprising both plastics materials and also other types of materials. The other types of materials in the feedstock may comprise one or more of biomass, municipal waste (such as https://wikiwaste.org.uk/Municipal_Solid_Waste #: ˜: text=Municipal % 20Solid%20Waste%20%E2%80% 93% 20or%20MSW,the%20clearance%20of%20Fly%2Dtipped, as viewed on 11 May 2023), metals, minerals and other waste products.

Embodiments include a number of modification and variations to the above described processes.

For example, the reforming system 115 may comprise separate reactors for reforming the pyrolysis gas and performing a gas capture process.

In the above described embodiments, a fast pyrolysis process is performed on the plastics from the feed 101. Embodiments include alternatively performing a slow pyrolysis process on the plastics from the feed 101.

In the above-described embodiments, air from an air supply conduit 116 is supplied to the reforming system 115. Embodiments include alternatively supplying substantially pure oxygen to the reforming system 115 through the air supply conduit 116. The substantially pure oxygen may have been generated by an air separation unit.

In the above described embodiments, both hydrogen and liquid fuels may be generated. Embodiments alternatively include operating the system so that the main fuel output of the system is the hydrogen in the first hydrogen conduit 120. All of the process for generating the hydrogen in the first hydrogen conduit 120 in dependence on the plastics from the feed 101 may therefore be performed. However, all of the described processes for generating the liquid fuel output from the main liquid output conduit 130 may only optionally be performed.

The flow charts and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1. A method of preparing hydrogen and liquid fuel from a feedstock that comprises plastics, the method comprising:
generating a first gas stream, that is a pyrolysis gas, by performing a pyrolysis process on a feedstock that comprises plastics;
condensing some of the first gas stream to generate a second gas stream and pyrolysis oil, wherein the second gas stream is a light component of the pyrolysis gas;
performing a reforming process on the second gas stream to generate hydrogen; and
generating liquid fuel by performing a hydrogenation process on the pyrolysis oil;
wherein the hydrogenation process reacts the pyrolysis oil with at least some of the generated hydrogen by the reforming process.

2. The method according to claim 1, wherein the feedstock substantially only comprises plastics such that the pyrolysis process is performed substantially only on plastics.

3. The method according to claim 1, wherein the pyrolysis process is a fast pyrolysis process.

4. The method according to claim 1, wherein:
the light component of the pyrolysis gas comprises C₁-C₄ hydrocarbons; and
the pyrolysis oil comprises C₅ or longer hydrocarbons.

5. The method according to claim 1, wherein the light component of the pyrolysis gas comprises one or more of methane, ethane, ethene, ethylene, propene, propylene, hydrogen, carbon monoxide and carbon dioxide.

6. The method according to claim 1, further comprising performing a steam gasification process on the second gas stream before the reforming process is performed on the second gas stream; and
wherein the gas supplied to the reforming process comprises one or more of methane, ethane, hydrogen, carbon monoxide and carbon dioxide.

7. (canceled)

8. The method according to claim 1, wherein the reforming process is a sorption enhanced steam reforming process.

9. The method according to claim 1, wherein the reforming process is pressure or temperature swing sorption enhanced steam reforming, whereby (i) steam reforming and CO₂ sorption occurs in a first reactor and sorbent regeneration occurs in a second reactor, and then (ii) sorbent regeneration occurs in the first reactor and steam reforming and CO₂ sorption occurs in the second reactor.

10. The method according to claim 1, wherein the temperature of the pyrolysis process is 300° C. to 600° C., preferably 400 to 450°.

11. The method according to claim 1, wherein the pressure of the pyrolysis process is 5 to 50 bar, preferably 5 to 20 bar;
wherein the temperature of the reforming process is 500° C. to 700° C., and preferably 600° C. to 650° C., or 625° C. to 675° C.;
wherein the pressure of the reforming process is 1 to 5 bar;
wherein the temperature of the steam gasification process is 400° C. and 800° C., and preferably 600° C.; and
wherein the pressure of the steam gasification process is 1 to 10 bar, and preferably about 5 to 10 bar.

12. (canceled)

13. (canceled)

14. (canceled)

15. (canceled)

16. The method according to claim 1, wherein the feedstock comprises a mixture of plastics and one or more of biomass, municipal waste, metals, minerals and other waste products.

17. A system for preparing hydrogen and liquid fuel from a feedstock that comprises plastics, the system comprising:
a pyrolysis reactor arranged to receive a feedstock that comprises plastics and to generate a first gas stream, that is a pyrolysis gas, by performing a pyrolysis process on the received feedstock;
a condenser arranged to condense some of the first gas stream to generate a second gas stream and pyrolysis oil, wherein the second gas stream is a light component of the pyrolysis gas;
a reforming system arranged to perform a reforming process on the second gas stream to generate hydrogen; and
a hydrogenation reactor arranged to generate liquid fuel by performing a hydrogenation process on the pyrolysis oil;
wherein the hydrogenation reactor is arranged to receive at least some of the generated hydrogen in the reforming system and to use the received hydrogen in the hydrogenation process.

18. The system according to claim 17, further comprising a steam gasification reactor arranged to perform a steam gasification process on the second gas stream before the second gas stream is supplied to the reforming system.

19. The system according to any of claim 17, wherein the system is arranged to perform a method comprising:
generating a first gas stream, that is a pyrolysis gas, by performing a pyrolysis process on a feedstock that comprises plastics;
condensing some of the first gas stream to generate a second gas stream and pyrolysis oil, wherein the second gas stream is a light component of the pyrolysis gas;
performing a reforming process on the second gas stream to generate hydrogen; and
generating liquid fuel by performing a hydrogenation process on the pyrolysis oil;
wherein the hydrogenation process reacts the pyrolysis oil with at least some of the generated hydrogen by the reforming process.

20. The system according to claim 17 , wherein the feedstock comprises substantially only plastics.

21. The system according to claim 17, wherein the feedstock comprises a mixture of plastics and one or more of biomass, municipal waste, metals, minerals and other waste products.

22. A method of preparing hydrogen from a feedstock that comprises plastics, the method comprising:
generating a first gas stream, that is a pyrolysis gas, by performing a pyrolysis process on the feedstock;
condensing some of the first gas stream to generate a second gas stream and pyrolysis oil, wherein the second gas stream is a light component of the pyrolysis gas;
performing a reforming process on the second gas stream to generate hydrogen.

23. The method according to claim 22, wherein the reforming process is a sorption enhanced steam reforming process.

24. The method according to claim 22, wherein the feedstock comprises substantially only plastics.

25. The method according to claim 22, wherein the feedstock comprises a mixture of plastics and one or more of biomass, municipal waste, metals, minerals and other waste products.

26. (canceled)
